(19) United States
(12) Patent Application Publication
(10) Pub. No.: US 2026/0316204 A1
(43) Pub. Date: Oct. 15, 2026

(54) MULTI-ORIENTATION WORKHOLDING BLOCK HAVING THREE-DIMENSIONAL PENTAGRAM GEOMETRY

(71) Applicant: TODD ROSS SIPES, TRAVELERS REST, SC (US)

(72) Inventor: TODD ROSS SIPES, TRAVELERS REST, SC (US)

(21) Appl. No.: 19/354,683

(22) Filed: Oct. 9, 2025

Related U.S. Application Data
(60) Provisional application No. 63/705,794, filed on Oct. 10, 2024.

(51) Int. Cl. B23Q 3/10

(52) U.S. Cl. CPC B23Q 3/10

(57) ABSTRACT

A multi-orientation workholding block is provided having a three-dimensional pentagram geometry that allows the block to rest stably in a plurality of orientations on a worksurface. Each orientation provides a different support height for a workpiece while maintaining the workpiece substantially parallel to the worksurface. The geometry of the block alone achieves multiple stable elevations without the use of additional components, fasteners, or mechanical adjustments. Contact faces of the block may include a friction-enhancing material such as silicone to improve grip with both the worksurface and the workpiece. The block may further include a through-hole having a non-circular cross-section for mounting on a post or holder, allowing quick storage and retrieval of multiple blocks. The invention provides a simple, self-contained, and versatile support device for elevating workpieces during cutting, sanding, routing, finishing, clamping, painting, or other operations.

### CROSS-REFERENCE TO RELATED APPLICATIONS

This application claims the benefit of U.S. Provisional Patent Application No. 63/705,794 filed Oct. 10, 2024 entitled “Workpiece gripping and elevating device with integrated wall mountable holder”, the entire disclosure of which is incorporated herein by reference

### FIELD OF THE INVENTION

The present invention relates generally to workholding devices for supporting a workpiece relative to a worksurface, and more particularly to a multi-orientation support block capable of providing different elevation heights without additional components, the block having a three-dimensional pentagram geometry that enables multiple stable orientations.

### BACKGROUND OF THE INVENTION

Workholding devices are commonly used to support a workpiece above a worksurface during operations such as cutting, sanding, routing, clamping, gluing, polishing, assembling, finishing, painting, among others. Conventional devices of this type, often referred to as bench cookies, support pucks, or work blocks, typically include a circular or polygonal body having opposing friction pads for engaging the worksurface and the workpiece.

While such devices are useful for elevating a workpiece and preventing surface marring, they generally provide only a single fixed height of support. To achieve multiple elevations, users must add additional components, insert spacers, or employ interchangeable parts, which can introduce instability, increase setup time, and limit versatility.

Accordingly, there exists a need for a simple, self-contained workholding device that can provide multiple stable orientations and corresponding support heights without additional parts, while maintaining secure frictional contact with both the worksurface and the workpiece.

### SUMMARY OF THE INVENTION

The present invention provides a multi-orientation workholding block configured to support a workpiece relative to a worksurface at multiple selectable heights without the use of additional components. The block comprises a body having a three-dimensional pentagram geometry that defines a plurality of distinct planar support surfaces and at least one apex region. The geometry enables the body to rest stably in a plurality of orientations upon a worksurface, each orientation presenting a different surface or region for contact with a workpiece. In at least two orientations, a planar support surface of the block is positioned substantially parallel to the worksurface, thereby supporting the workpiece at different elevations. In another orientation, the block rests on one of the planar surfaces such that the apex region is uppermost, allowing a plurality of the blocks to cooperate in defining a substantially parallel support plane for the workpiece.

The block is preferably composed of, or includes contact regions formed from, a friction-enhancing resilient material, such as silicone, to inhibit sliding relative to the worksurface and the workpiece without the use of mechanical fasteners, suction, or adhesives.

In certain embodiments, the body further defines a through-hole extending entirely through a central region of the geometry. The through-hole may have a non-circular cross-section, such as a rounded-rectangular shape, to resist rotation when engaged with a complementary post or fixture. This configuration enables the block to be mounted on or removed from a storage holder or accessory quickly and securely, facilitating convenient storage and organization of multiple blocks and providing opportunities for additional accessory attachments.

The invention thus provides a simple, stable, and versatile workholding device that offers multiple elevation heights and orientation options within a single, self-contained structure.

### DEFINITIONS

As used herein, the term “three-dimensional pentagram geometry” refers to a body having a solid shape derived from a five-sided or five-pointed star-like outline extended or extruded in three dimensions. The geometry includes five outwardly projecting arms, points, or sides arranged generally in a circumferential pattern about a central region, such that the body defines multiple planar and non-planar support surfaces that intersect or meet at distinct edges or vertices.

The geometry is configured such that the body can be stably supported in at least three distinct orientations on a generally planar worksurface, each orientation presenting a different one of the support surfaces (or an apex region) for contact with a workpiece. In at least two of these orientations, a planar portion of the geometry defines an upper surface substantially parallel to the worksurface, thereby supporting a workpiece at a first or second elevation. In another orientation, the body rests on a planar region while an apex region or point of the geometry provides an elevated contact region for the workpiece, whereby a plurality of such bodies can collectively define a substantially parallel support plane for the workpiece.

The three-dimensional pentagram geometry may be solid, hollow, or partially filled, and may include rounded, chamfered, or truncated points or edges without departing from the concept of a pentagram-derived solid. The term encompasses any three-dimensional form derived from, resembling, or functionally equivalent to a pentagram-or five-sided-shaped solid that provides multiple distinct, stable orientations and parallel support functionality as described herein.

Unless otherwise indicated, all directional references (such as “upper,” “lower,” “top,” “bottom,” etc.) are made with respect to the orientation of the block as shown in the drawings and are not intended to be limiting.

### BRIEF DESCRIPTION OF THE DRAWINGS

FIGS. 1A-1C are perspective views of a workholding block according to an embodiment of the invention, showing three different stable orientations that provide distinct workpiece-support heights.

FIGS. 2A-2C illustrate example arrangements of multiple blocks in the different orientations shown in FIGS. 1A-1C, corresponding to different potential support heights.

FIGS. 3A-3C are schematic side views showing the relative relationship between the worksurface, the blocks, and the supported workpiece in each of the three orientations.

FIGS. 4A-4D are views illustrating the geometric configuration of the block, including the planar support surfaces, apex region, and symmetry that enable the block to provide a parallel support plane in each orientation.

FIGS. 5A-5C illustrate the through-hole extending through the block and example holders or storage fixtures configured to receive the blocks for organized storage.

### DETAILED DESCRIPTION OF THE DRAWINGS

Reference will now be made to the drawings, in which like reference characters refer to like elements throughout the several views. The drawings illustrate various embodiments of a multi-orientation workholding block (hereinafter referred to simply as “block” or “blocks”) having a three-dimensional pentagram geometry as defined herein. The figures are not necessarily to scale and are provided to facilitate an understanding of the structure and operation of the invention rather than to limit its scope.

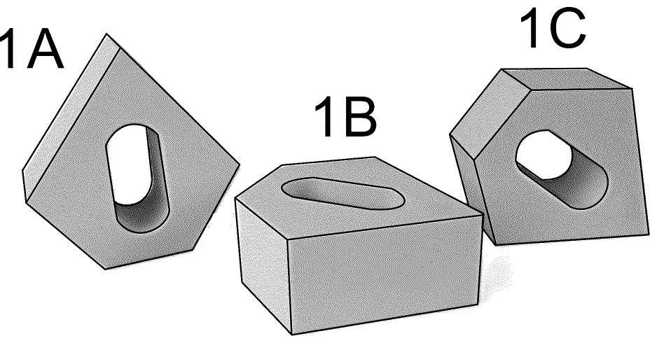

In the drawings, reference “WP” designates a workpiece supported by one or more of the blocks, and reference “WS” designates a worksurface upon which the blocks are positioned. In certain figures, the letter “C” denotes the block itself. The blocks are typically used in sets of four or more, although a single block may be used where suitable. The following description explains the structure, geometry, and use of the blocks with reference to FIGS. 1A-5C.

### FIGS. 1A-1C—Multiple Orientations and Support Heights

Referring now to FIGS. 1A-1C, the drawings show the same workholding block placed in three different stable orientations. Each orientation provides a different height at which a workpiece can be supported above a worksurface.

In FIG. 1A, the block is turned so that one of its flat sides rests on the worksurface and the pointed apex of the pentagram shape faces upward. In this orientation, the tip of the apex becomes the point of contact with the workpiece, producing the highest support height. When several blocks are used together in this orientation, the points of the apexes collectively form a plane that is parallel to the worksurface, allowing the workpiece to remain level.

In FIG. 1B, the block is positioned on one of its broad, flat sides. The opposite flat side then becomes the upper surface that supports the workpiece. In this position, the block provides the lowest working height.

In FIG. 1C, the block is rotated to rest on another of its sides. This orientation presents a different upper surface that is again parallel to the worksurface but sits higher than in FIG. 1B, giving the middle height option.

All of the contact faces of the block—both the upper and lower surfaces and the apex tip—are made from, or coated with, a high-friction material such as silicone. This material helps prevent sliding and keeps both the block and the workpiece stable in every orientation. The geometry of the pentagram shape itself gives the block stable balance in all three positions without any extra components or fasteners.

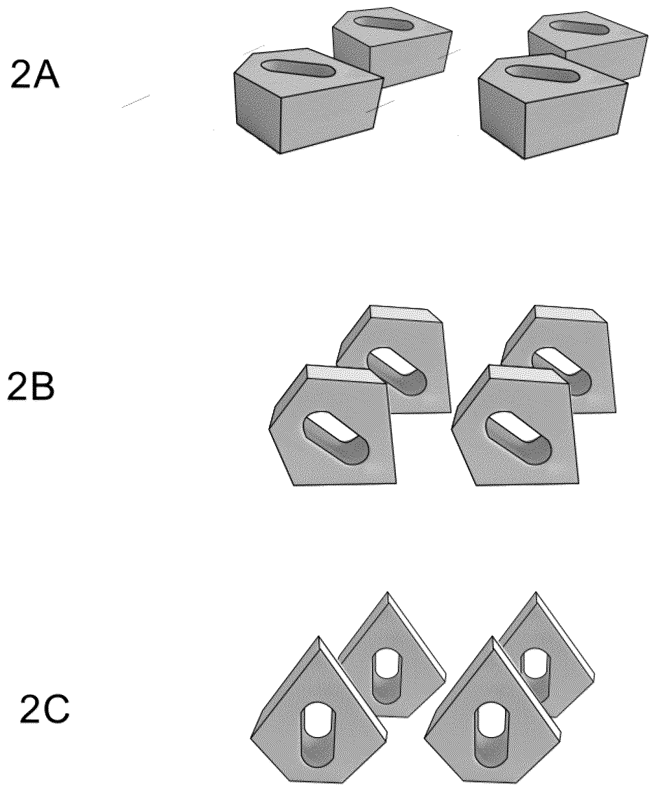

### FIGS. 2A-C—Example Layouts of Multiple Blocks

Referring to FIGS. 2A-2C, the drawings show how several of the blocks can be positioned on a worksurface to support a workpiece at different heights. In each example, four blocks are used, although any number may be arranged as needed depending on the size and shape of the workpiece. The blocks are typically placed near the corners or other evenly spaced points so that the workpiece remains balanced and stable.

In FIG. 2A, all of the blocks are positioned in their lowest orientation, the same as shown in FIG. 1B. This provides the minimum elevation of the workpiece above the worksurface.

In FIG. 2B, the blocks are placed in the second orientation, corresponding to the middle height shown in FIG. 1C. This raises the workpiece to an intermediate level while keeping it parallel to the worksurface.

In FIG. 2C, the blocks are used in the third orientation, with the pointed apexes facing upward as in FIG. 1A. When the workpiece rests on the tips of the apexes, the workpiece sits at the highest working height. The geometry of the blocks ensures that, even though each block touches the workpiece only at its apex, the overall support plane remains parallel to the worksurface.

These arrangements demonstrate that a user can quickly select the desired working height simply by rotating each block to a different side, without adding or removing parts. The blocks rely only on their shape and the grip of the silicone surfaces to stay in position.

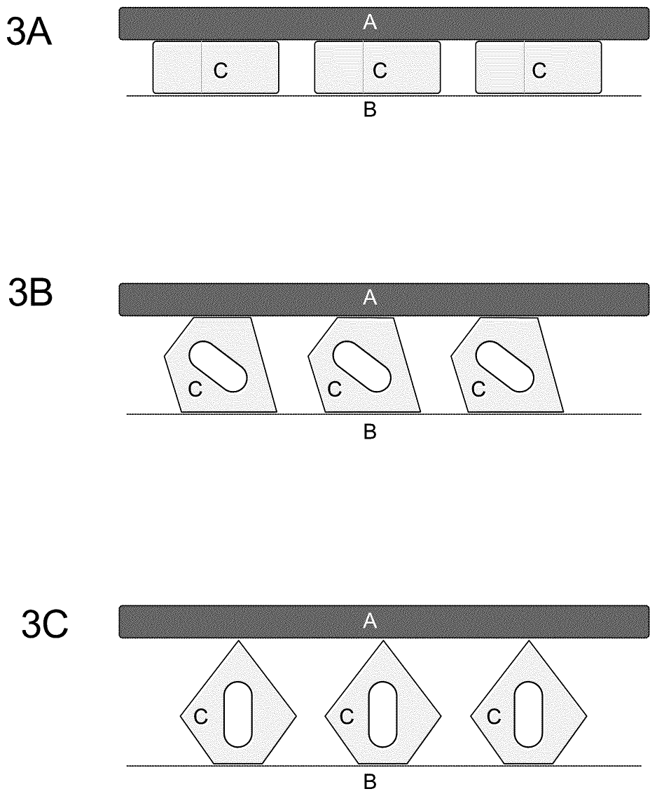

### FIGS. 3A-3C—Relationship Between the Block, Workpiece, and Worksurface

Referring to FIGS. 3A-3C, these drawings illustrate how the block supports a workpiece above a worksurface in each of the three available orientations. In all three figures, the letter A represents the workpiece, B represents the worksurface, and C represents the block or blocks that provide support.

In FIG. 3A, the block is shown in its lowest orientation. The workpiece rests on the upper surface of the block, and both the upper surface and the worksurface are parallel to one another. This orientation provides a stable, low elevation suitable for operations such as (but not limited to) sanding, routing, planing or cutting close to the table surface.

In FIG. 3B, the block is positioned in its second, middle orientation. The workpiece is again supported in a plane that is parallel to the worksurface, but at a greater height. This arrangement may be useful when additional clearance is needed for operations such as clamping, gluing, assembly of projects among others.

In FIG. 3C, the block is shown in its third and highest orientation, with the pointed apex facing upward. The workpiece rests on the tips of the apexes of several blocks arranged as described in FIG. 2C. Even though each block touches the workpiece only at a single point, the geometry of the blocks ensures that all apex tips lie on a common plane, so the workpiece remains parallel to the worksurface.

These figures demonstrate that, regardless of which orientation is used, the block supports the workpiece securely and evenly, without requiring additional components, mechanical fastening or adjustment devices.

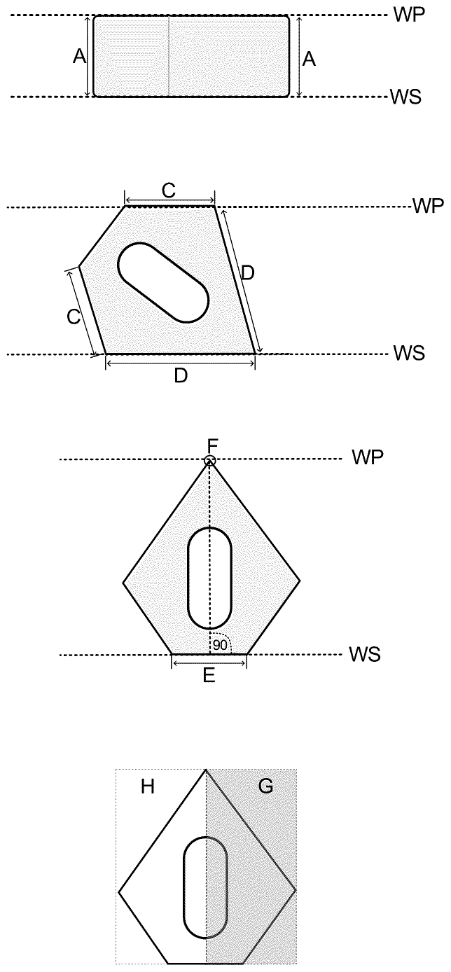

### FIGS. 4A-4D—Geometry, Parallel Surfaces, and Symmetry of the Block

Referring to FIGS. 4A-4D, these drawings illustrate how the geometry of the block ensures that, in each of its orientations, the surface supporting the workpiece remains parallel to the worksurface. They also show the symmetry and balance that give the block stability in all three positions.

In FIG. 4A, the block is shown in its lowest orientation. The height of the block, measured from the worksurface to the upper face that supports the workpiece, is even on all sides, so the upper surface lies parallel to the worksurface.

In FIG. 4B, the block is in its middle orientation. The figure shows that each of the sides marked “C” has an opposite side marked “D,” and that these opposite sides are parallel to one another. Both “C” sides are equal in length, and both “D” sides are equal in length, but the “C” sides and “D” sides are of different lengths. This relationship between the sides allows the upper surface of the block to remain parallel to the worksurface while producing a higher support height than in FIG. 4A.

In FIG. 4C, the block is in its highest orientation, with the pointed apex uppermost. The figure shows that the vertical centre line of the block, drawn at a right angle from the base edge “E,” passes directly through the tip of the apex and through the centre of the hole formed through the block. This relationship ensures that the apex lies on the same vertical axis as the centre of the block, giving balanced support and preventing tipping when a workpiece rests on several of the apex points.

In FIG. 4D, the block is shown again in its highest orientation, viewed from the front to illustrate left-to-right symmetry. The portions of the block identified by rectangles “G” and “H” show that the shape is symmetrical about its centreline, meaning that the left and right halves are mirror images of each other. This symmetry contributes to the block's overall stability in all orientations.

Together, these figures show that the unique pentagram-derived geometry provides both structural balance and consistent parallel alignment between the workpiece and the worksurface, regardless of which side or point the block is resting on.

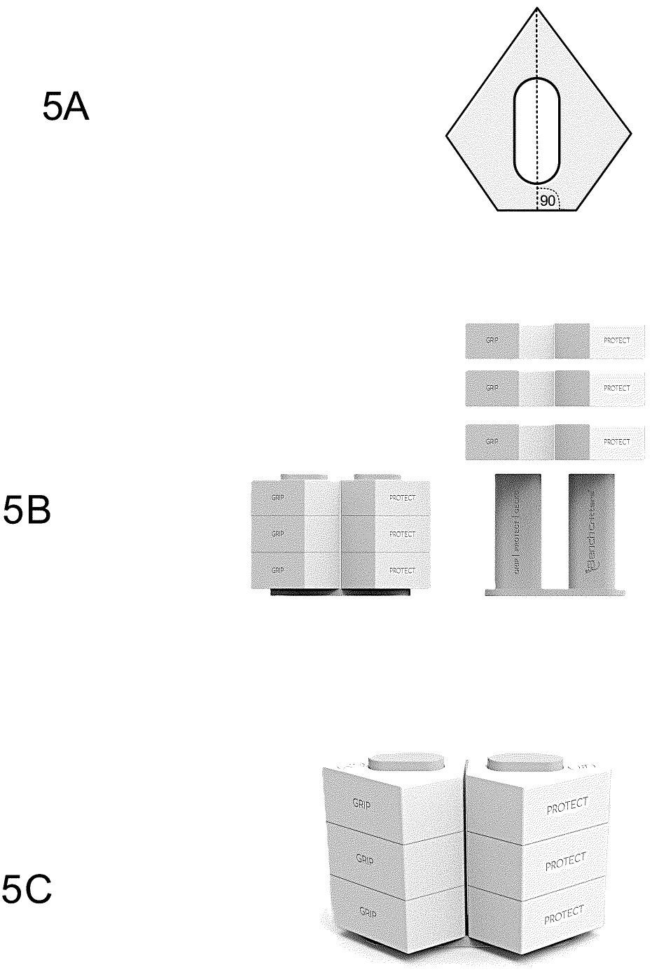

### FIGS. 5A-5C—Through-hole and Storage Holder

Referring to FIGS. 5A-5C, these drawings show the hole that passes completely through the centre of the block and how that feature allows the blocks to be stored or mounted on a holder.

In FIG. 5A, the hole is shown from above. It passes straight through the body of the block from one face to the opposite face. The hole has a rounded-rectangular shape, meaning that its sides are generally straight but its corners are curved. This shape allows the block to slide smoothly onto a post or peg of matching shape, while also preventing rotation once in place. The hole is positioned along the vertical centre line of the block so that the block remains balanced when placed on a post.

In FIG. 5B, several blocks are shown slid onto the posts of a wall-mountable holder. The holder includes one or more posts that match the shape of the hole in the block. Because the hole and post share the same non-circular cross-section, the blocks can be easily placed onto or removed from the holder but cannot spin or twist while stored.

In FIG. 5C, multiple blocks are shown mounted on the holder, neatly stacked and ready for use. This arrangement allows the blocks to be stored together in an organised way, saving space and keeping them readily accessible when required. The same hole can also be used for attaching the block to other accessories or fixtures that may be developed to extend the block's functionality.

These figures show that the inclusion of the through-hole adds a convenient storage and accessory-mounting feature without affecting the balance or operation of the block when used as a workholding device.

### General Description and Alternatives

The embodiments of the invention described above are provided as examples to explain how the workholding block and its features can be made and used. It will be understood that many variations are possible without departing from the overall concept. For instance, the size of the block, the proportions of the pentagram shape, the type of friction material, or the exact dimensions and position of the through-hole may be changed to suit different applications. The block may be produced from a variety of materials, including plastics, rubbers, metals, or composites, and may be used individually or in sets of any number. Other holders or accessories may also be developed to engage with the through-hole or with other portions of the block. All such modifications and equivalent arrangements are considered to fall within the spirit and scope of the invention as defined by the following claims.

What is claimed is:

1. A workholding device comprising:
a body having a three-dimensional pentagram geometry as herein defined, the body including a plurality of planar support surfaces and at least one apex region;
the geometry being such that the body can rest stably in at least three distinct orientations upon a generally planar worksurface, each orientation providing a different support height for a workpiece relative to the worksurface;
in at least two of the orientations, a planar surface of the body lies substantially parallel to the worksurface to support the workpiece at different elevations;
and in another orientation, the apex region provides an elevated contact region for supporting the workpiece while maintaining the workpiece substantially parallel to the worksurface;
wherein the geometry of the body alone enables the multiple stable orientations and support heights without the use of additional components, fasteners, or mechanical adjustment mechanisms.

2. The workholding device of claim 1, wherein each of the planar support surfaces and the apex region includes a friction-enhancing contact surface configured to resist sliding relative to the worksurface and the workpiece.

3. The workholding device of claim 2, wherein the friction-enhancing contact surface comprises silicone or a silicone-based material.

4. The workholding device of claim 1, wherein the body further defines a through-hole extending completely through the body between opposite sides of the geometry.

5. The workholding device of claim 4, wherein the through-hole has a non-circular cross-section, thereby inhibiting rotation of the body when mounted on a post or fixture.

6. The workholding device of claim 5, wherein the non-circular cross-section is rounded-rectangular.

7. The workholding device of claim 4, wherein the through-hole is configured to receive a post of a holder, rack, or accessory fixture for storing or organizing the body when not in use.

8. The workholding device of claim 1, wherein the body is formed of a resilient or elastomeric material that compresses slightly under load to improve grip and stability.

9. A system comprising a plurality of the workholding devices of claim 1 arranged on a worksurface to support a workpiece at a selected elevation relative to the worksurface.

10. The system of claim 9, wherein the plurality of workholding devices are oriented with their respective apex regions uppermost so that the workpiece is supported on a plane defined by the apex regions.

11. A method of supporting a workpiece, comprising:
placing at least one workholding device according to claim 1 on a worksurface with a selected planar support surface in contact with the worksurface; and
positioning a workpiece on another planar support surface or on the apex region of the workholding device to support the workpiece at a chosen elevation without using additional components, fasteners, or mechanical adjustment mechanisms.
